(19) United States
(12) Patent Application Publication
(10) Pub. No.: US 2013/0173210 A1
(43) Pub. Date: Jul. 4, 2013

(54) METHOD FOR DETERMINING AN AVERAGE ROTATIONAL SPEED OF A ROTATING TRANSMISSION SHAFT OF AN INTERNAL COMBUSTION ENGINE

(71) Applicants: Matthias Cwik, Stuttgart (DE); Markus Roessle, Stuttgart (DE); Ewald Mauritz, Weissach (DE); Stefan Tumback, Stuttgart (DE)

(72) Inventors: Matthias Cwik, Stuttgart (DE); Markus Roessle, Stuttgart (DE); Ewald Mauritz, Weissach (DE); Stefan Tumback, Stuttgart (DE)

(21) Appl. No.: 13/728,057

(22) Filed: Dec. 27, 2012

(30) Foreign Application Priority Data
Dec. 29, 2011 (DE) 102011090077.2

(51) Int. Cl. G01M 15/04; G06F 17/00

(52) U.S. Cl. CPC G01M 15/04; G06F 17/00
USPC 702/145; 73/115.01

(57) ABSTRACT

A method for determining an average rotational speed of a rotating transmission shaft of an internal combustion engine to a rotational position is described, the rotating transmission shaft taking on various rotational positions and having an actual instantaneous rotational speed at a first time in the rotational position. At a first approximation in a first step, an approximated average rotational speed is determined, as the difference of the actual rotational speed at the first time and in the rotational position, and the product of a weighted amplitude and an angle-dependent amplitude factor.

### CROSS REFERENCE TO RELATED APPLICATION

The present application claims priority to Application No. DE 10 2011 090 077.2, filed in the Federal Republic of Germany on Dec. 29, 2011, which is incorporated herein in its entirety by reference thereto.

### FIELD OF INVENTION

The present invention relates to a method for determining an average rotational speed of a rotating transmission shaft of an internal combustion engine.

### BACKGROUND INFORMATION

It is known from the related art that one may precalculate a speed prediction from only a few singular points of the coasting down of the engine. German Application No. DE 10 2006 041 037 A1 describes that one may undertake the precalculation of the speed (rotational speed) and of the time of the next top dead center (TDC) and bottom dead center (BDC) based on the rotational speed pairs/time pairs of the latest ignition TDC's and BDC's.

German Application No. DE 10 2010 009 648 A1 describes that one may ascertain an average coasting down from a known section of the coasting down and then, with the aid of known typical properties, which are a function of the angular position of the transmission shaft, to ascertain a prediction of the actual rotational speed in the future.

### SUMMARY

In the coasting down internal combustion engine the speed and the crankshaft position over time are to be precalculated for any desired point in time. The additional method according to the present invention, provided here, makes possible the prediction of the further coasting down, and in the process, the current engine parameters and current environmental conditions, that are decisive for this coasting down, are taken into consideration.

In response to the switching off of an internal combustion engine (one-cylinder, multi-cylinder, gasoline vehicle, Diesel) it does not immediately come to a standstill, but coasts down in a characteristic manner. In particular, one may ascribe to the running down an average slope (speed over time), and it represents the linear portion of the running down. The average slope is essentially determined by the instantaneously effective frictional torque and load torque on the internal combustion engine.

Based on the compression and decompression cycles, a characteristically oscillating, engine type-dependent portion is superposed on this linear portion. This oscillating portion is determined essentially by the energy conversion of kinetic energy to potential energy (compression energy) and vice versa. For each engine type, a characteristic energy transformation curve (ETF characteristics curve) is able to be formulated. It gives the rotational speed amplitude (normalized to one) as a function of the crankshaft position.

It is an advantage of the method to ascertain the amplitude-compensated rotational speed from the actually measured rotational speeds via an iterative method. In response to correct compensation, the compensated rotational speeds will lie on a straight line. Via these linear rotational speeds one may average suitably and determine the average coasting down slope and the interpolation point for the prediction. The method takes into account the physical effect that the maximum amplitude of the oscillating portion is a function of the rotational speed (amplitude characteristics curve) and one uses for the iterative determination of the compensated rotational speed, from the real rotational speed, the so-called ETF characteristics curve.

For the prediction of the further coasting down, the slope thus ascertained (gradient) is updated into the future. The oscillating portion is superposed on this linear curve using the ETF characteristics curve. In the prediction, too, the method takes into account the physical effect that the maximum amplitudes of the oscillating portion are a function of the rotational speed.

An advantage of this method is that the speed prediction is not only calculated for a few individual points, but that the speed curve is able to be precalculated for any number of time steps and angle steps or rotational speed steps.

Furthermore, it is advantageous, compared to existing methods, that the analysis of the coasting down of the engine is based on multiple input data (namely, all available coasting down data). A deviation in the individual data set thus has only a slight effect on the analysis of the entire coasting down.

In addition, it is advantageous that the prediction data are not available only after the expiration of a period, but a prediction is available at each event time.

A further advantage is that the method builds up on data already recorded on the current coasting down. This means that the engine-specific and environment-specific influences, which have an effect on the slope of coasting down and the compression amplitude, are automatically taken into account in the respective prediction. These are among other things: short and long-term varying frictional and load torques on the internal combustion engine (electrical consumers, air conditioning system, etc.), short and long-term varying intake manifold pressure (as a function of the throttle valve setting, air pressure, height above sea level pressure, etc.) and varying leakages in the compression cycle (due to engine aging, etc.).

The method described may be used in start/stop systems, in which the intention is to engage the starter, or rather its pinion, in the engine that is still rotating, or rather the gear rim. In this instance, for the synchronous engaging of the starter, the rotational speed of the internal combustion engine, at various points in time, has to be known ahead of time.

The system may also be used in start/stop systems, in which the starter or its pinion engages with the internal combustion engine or the gear rim that have just come to a standstill or are rotating at a low residual rotational speed. At this point, the time at which the engine is certainly at rest or the rotational speed is below a rotational speed threshold has to be calculated.

The method may also be used in engine control units. In that case it may be precalculated when the engine will certainly stand still, or the rotational speed is below or still above a specified rotational speed threshold.

### BRIEF DESCRIPTION OF THE DRAWINGS

The present invention will be described in greater detail in the following text with reference to the accompanying figures.

FIG. 1 shows in exemplary fashion the rotational speed response of a transmission shaft of an internal combustion engine in a polygon.

FIG. 2 shows an average coasting down straight line.

FIG. 3 shows in exemplary fashion, an undercompensation.

FIG. 4 shows in exemplary fashion, an overcompensation.

FIG. 5 shows an example of a good periodic determination of a compensation straight line.

FIG. 6 shows an example of a non-optimal periodic determination of a compensation straight line.

FIG. 7 shows a few predictions, as examples.

FIG. 8 shows a schematic representation of an internal combustion engine.

### DETAILED DESCRIPTION

For an engine, or an internal combustion engine that is just coasting down, a normalized engine-type specific energy transformation characteristics curve (ETF characteristics curve) is able to be formulated. It is made available to a CPU in a suitable manner, e.g., as a look-up table. Such a characteristics curve is known from the related art. It indicates, accurate as to angle (crankshaft angle), what portion of the maximum potential energy has just been converted to kinetic energy at the crankshaft. That is, the ETF characteristics curve characterizes the cyclically occurring energy conversion from potential energy to kinetic energy, and vice versa. The minima of the ETF characteristics curve typically lie at the ignition top dead center positions of the internal combustion engine. At that point, the energy stored during compression is at a maximum and is consequently “missing” as a contribution to the kinetic energy.

For an internal combustion engine that is coasting down, an engine-specific “standard” amplitude characteristics curve may be formulated. It is made available to the CPU in a suitable manner, e.g., also as a look-up table. During the amplitude compensation method, the amplitude characteristics curve, as described in German Application No. DE 10 2010 009 648 A1, is used, the contents of which are expressly incorporated herein in their entirety by reference thereto.

After the injection/firing, the internal combustion engine is coasting down. During coasting down, rotational speed data and crankshaft position data are available together with the time information, in a paired manner. For each coasting down, preferably at all or at selected event points, data are first recorded, these data are then processed in a CPU. Based on the actually recorded data, the further coasting down is then precalculated.

Thereafter, one then first goes ahead with the iterative determination of a compensated or linearized rotational speed.

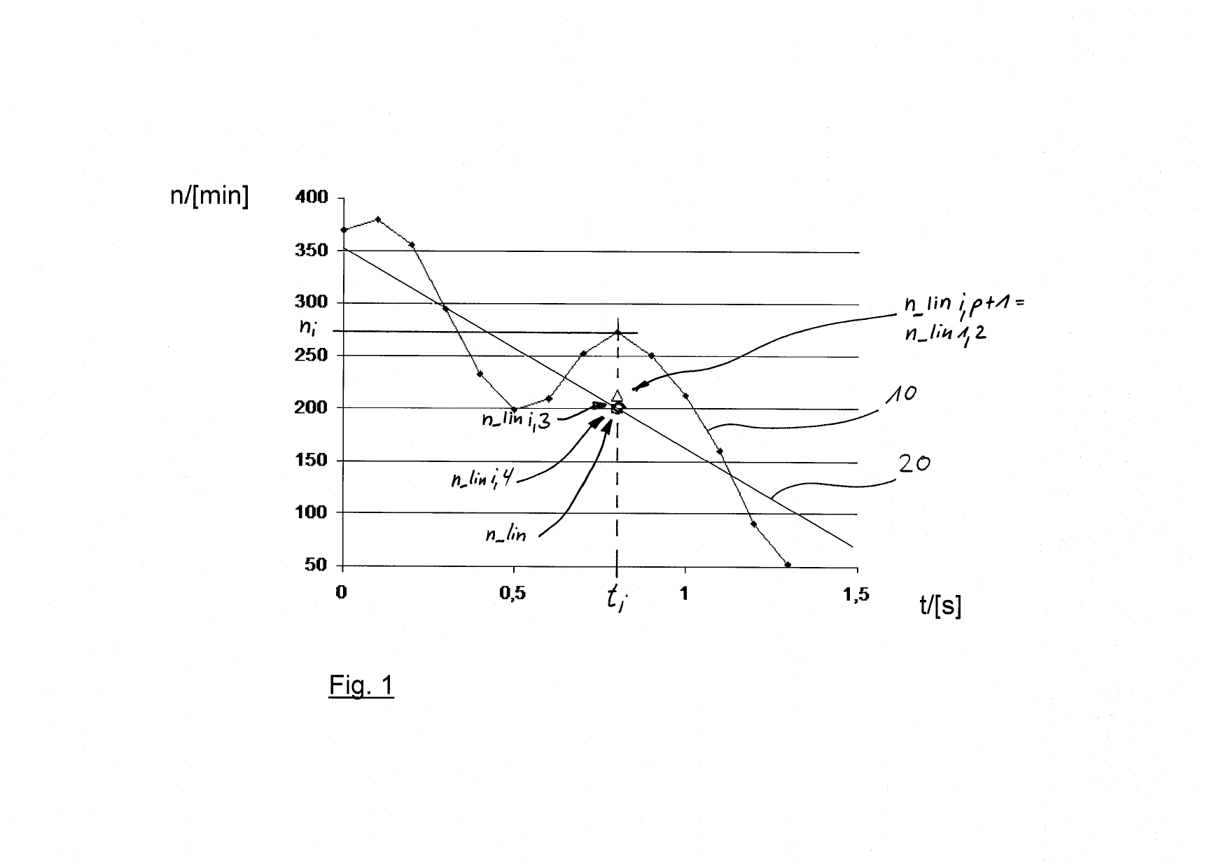

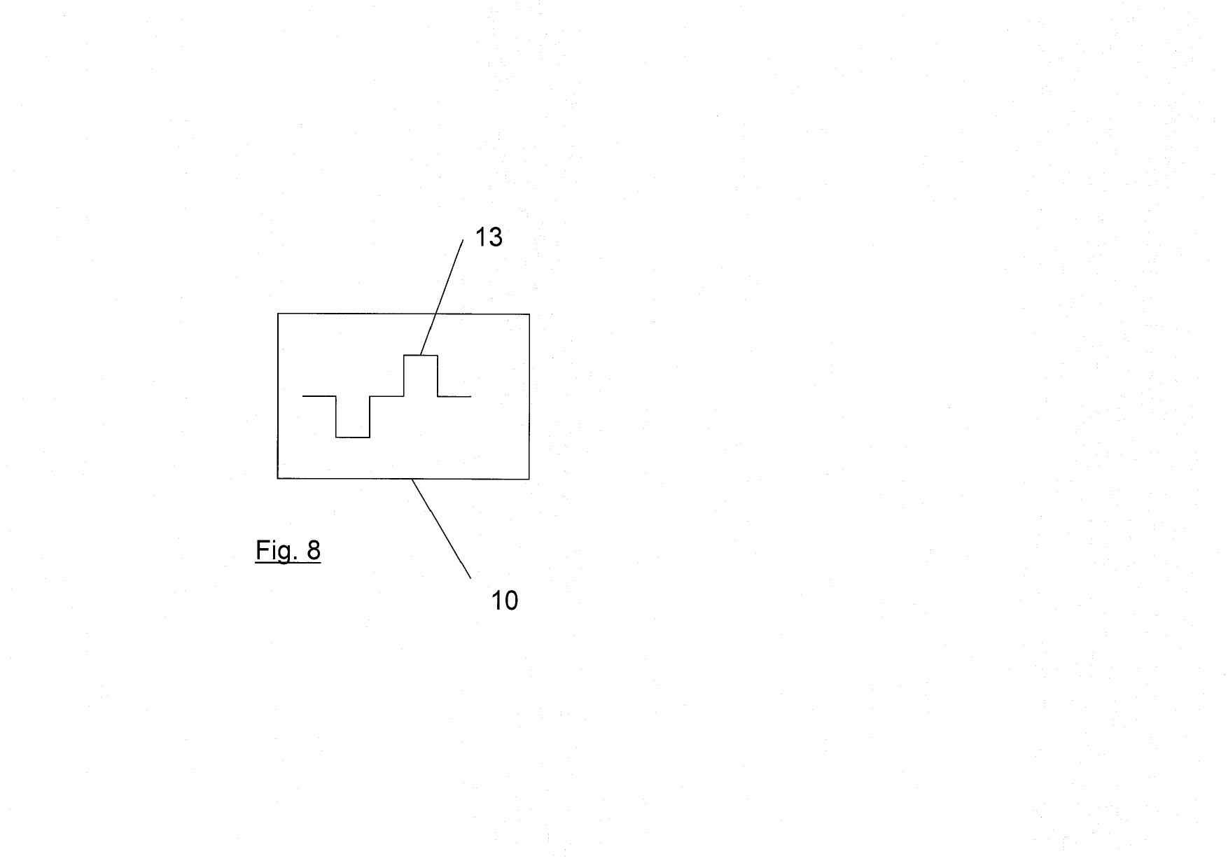

In FIG. 1, for example, the rotational speed response of a transmission shaft 13 (FIG. 8) of an internal combustion engine is shown in a polygon 10. Furthermore, an average coasting down straight line 20 is shown. For a point at t=0.8 s, the actual rotational speed value ni=275/min as well as additional values are shown. Among these is an iteratively ascertained value which is designated by a triangle. This value is designated here by “n_lin i,p+1”=n_lin1,2=212/min (p=1, first iteration step; i=current point in time), and has the magnitude named. Using an additional iteration step, p=2, the value for “n_lin i,p+1”=n_lin i,3=204/min was calculated (designated by a square standing on one vertex). Using a further iteration step, that is the last in this case, p=3, the value “n_lin i,p+1”=n_lin i,4=200/min was calculated. This value coincides with the actual average value n_lin.

In the ascertainment of the iteratively ascertained values, the procedure is as follows: starting from the current actual rotational speed ni, n_lin i,p+1 comes about as the first approximation to a compensated (linearized) rotational speed as the difference of the current actual rotational speed ni less the product of a weighted amplitude ampl_weightp (n_lini,p) and an angle-dependent amplitude factor ampl_ETFi (phi(i)).

n_{—}lin i,p+1=n_actuali−ampl_weightp(n_{—}lini,p)*ampl_{—}ETFi(phi(i)) (1)

where p=1 and n_lini,1=n_actuali=ni. p is an iteration counter, e.g., p=1 to 4, ampl_weight is a rotational speed dependent weighted amplitude, ampl_ETF is an angle-dependent amplitude factor from the ETF characteristics curve, angle phi(i) is the transmission shaft angle at time i.

For subsequent iteration steps, for n_actuali, n_lin i,p+1 is used that was ascertained before each time in the iteration step.

Thus n_lin i,p+1=n_lin i,2 is yielded by

n_{—}lini,2=ni−ampl_weightp(n_{—}lini,2)*ampl_{—}ETFi(phi(i))=212/min. (2)

n_lin i,p+1=n_lin i,3 is yielded by

n_{—}lin i,3=n_{—}lini,2−ampl_weightp(n_{—}lin i,3)*ampl_{—}ETFi(phi(i))=204/min, (3)

n_lin i,p+1=n_lin i,4 is yielded by

n_{—}lin i,4=n_{—}lin i,3−ampl_weightp(n_{—}lin i,4)*ampl_{—}ETFi(phi(i))=200/min. (4)

The amplitude factor is consequently the same for all iteration steps. The “weighted amplitude”, on the other hand, is a function of the respectively previously ascertained approximated average rotational speed n_lini,p+1.

Consequently, there is a method for determining an average rotational speed n_lini,p+1 of a rotating transmission shaft 13 of an internal combustion engine 10 to a rotational position phi(i), whereby the rotating transmission shaft 13 takes on various rotational positions phi(i) and has an actual instantaneous rotational speed ni at time ti in rotational position phi(i), at a first approximation in a first step p−1, an approximated average rotational speed n_lini,p+1 being determined, which is determined as a difference of the actual rotational speed ni at time ti in rotational position phi(i) and a product of a weighted amplitude ampl_weightp (n_lini,p) and an angle-dependent amplitude factor ampl_ETFi(phi(i)).

Furthermore, it is provided that in an additional step p=2 of the iteration, a further approximated average rotational speed n_lini,2+1 be determined as a difference of the average rotational speed n_lini,1+1, approximated in the previous step, at time ti and the product of a rotational speed-dependent, weighted amplitude ampl_weightp(ti) and an angle-dependent amplitude factor ampl_ETFi(phi(ti)).

For each point in time ti, a plurality of iteration steps, preferably three or four, should be carried out in order to ascertain additionally approximated average rotational speeds n_lini,3+1; n_lini,4+1; n_lini,p+1, where p is a positive integer.

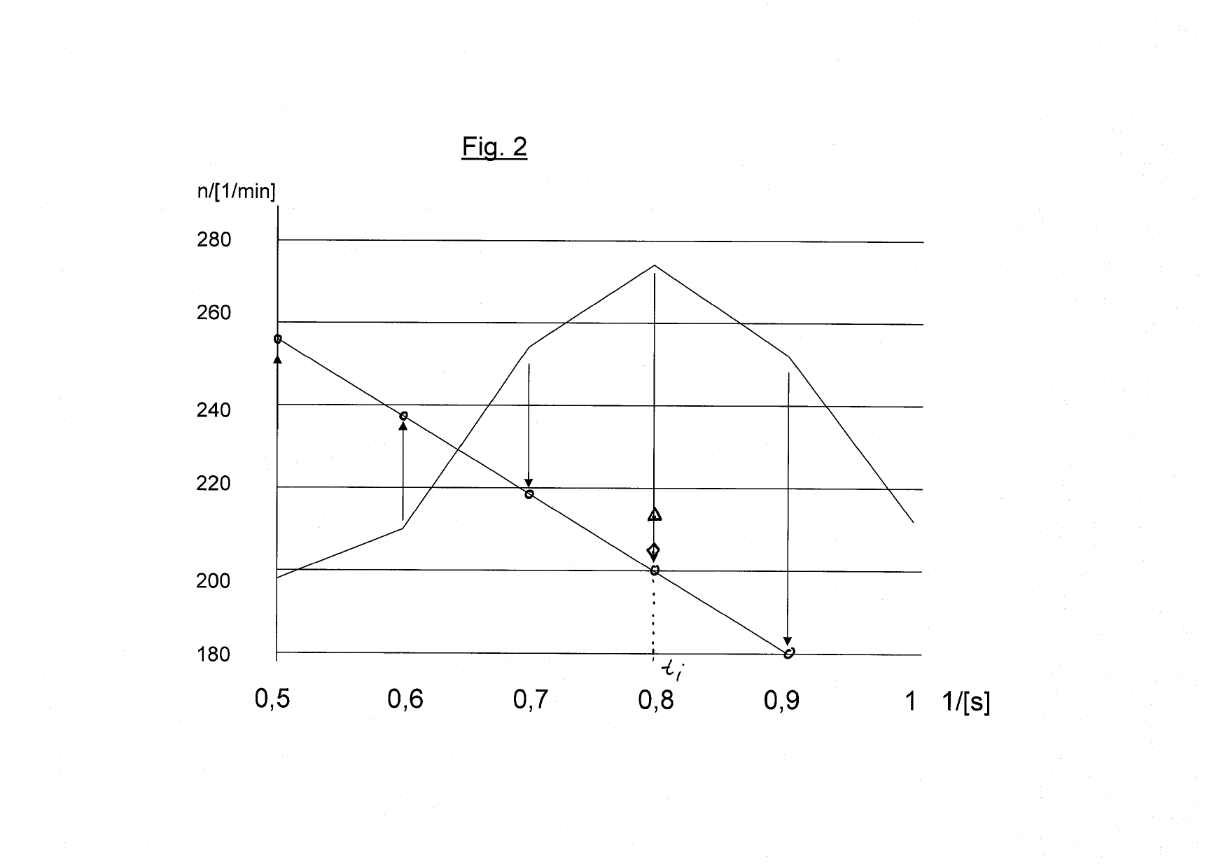

If the given calculation method is applied to adjacent points, there comes about, for example, the relationship shown in FIG. 2, and detectable with that, an average coasting down straight line 20.

From the linearized rotational speeds determined using amplitude compensation, the coasting down slope is then determined. This may be done in various ways. The generally known method of linear regression is preferably used (method of least squares of errors). Using a linear regression calculation, from the time and rotational speed coordinates, one then determines the slope and the end point of the average best fit line. As soon as more than one slope value is obtained, and using known average value formation methods, one may then determine an optimized average coasting down slope. For best results, a triple moving average value may be used.

A coasting down slope m(ti) is ascertained from at least two values for average rotational speeds n_lini,p+1.

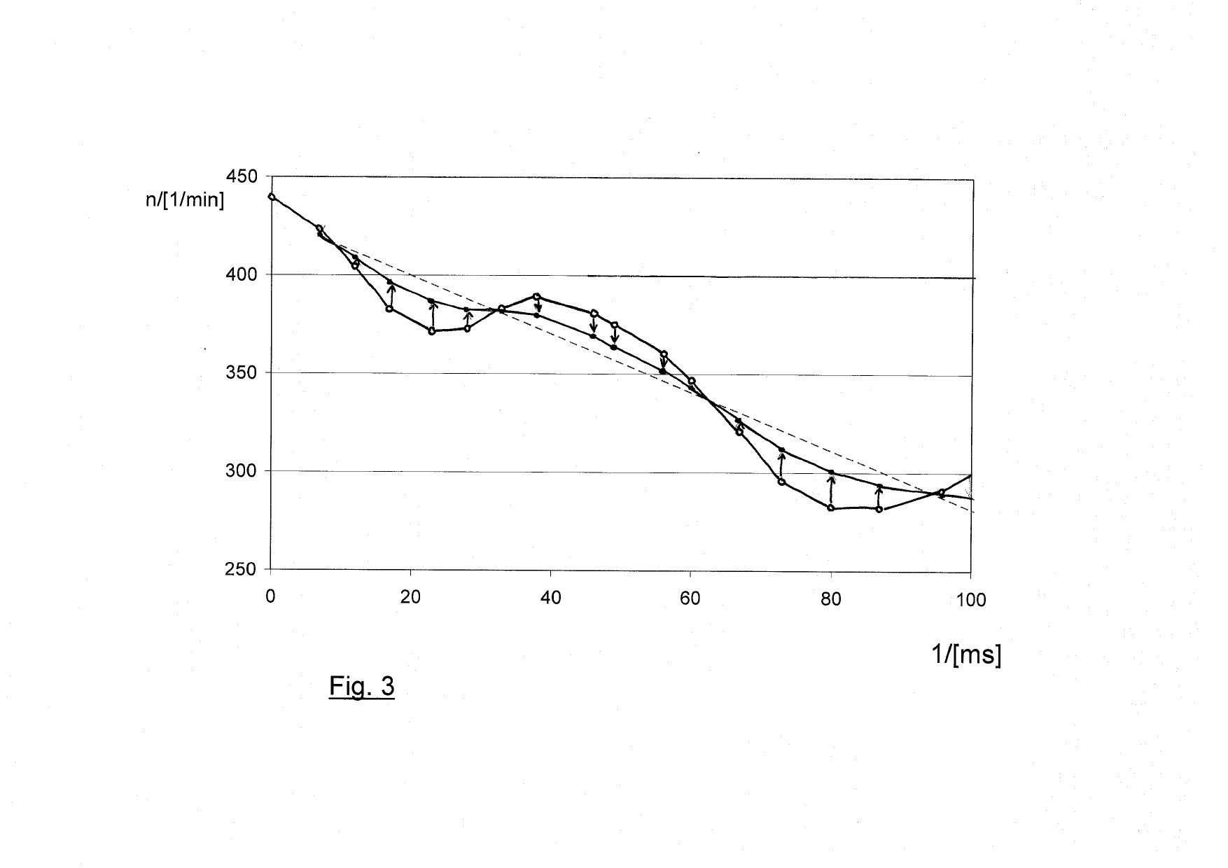

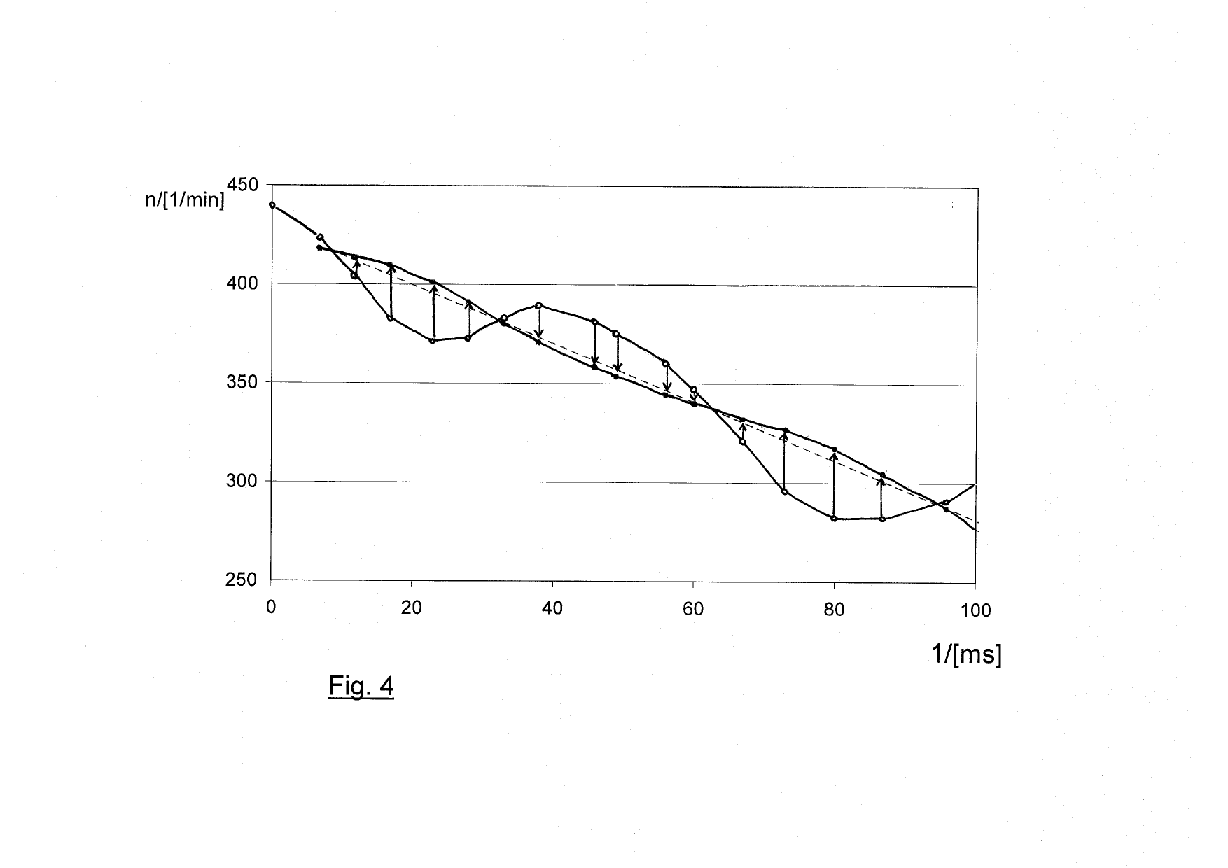

Within the scope of the method shown here, both undercompensation (FIG. 3) and overcompensation (FIG. 4) may take place.

In the case of overcompensation or undercompensation, the compensated-for rotational speeds do not lie closely enough to the straight trend line. Rather, they fluctuate about the straight trend line at a systematically increasing and decreasing distance. In this case, advantageously not all available value pairs are drawn upon to form the straight trend lines, but only a selected range.

For instance, a periodic determination of the straight trend line has proven itself. The period starts at crankshaft angles for which the ETF characteristics curve is at a maximum and ends at an angle having the next maximum, or one subsequent to that. One may also consider a start at crankshaft angles for which the ETF characteristics curve is at a minimum, but in this case the range then goes from the minimum to one of the subsequent minima.

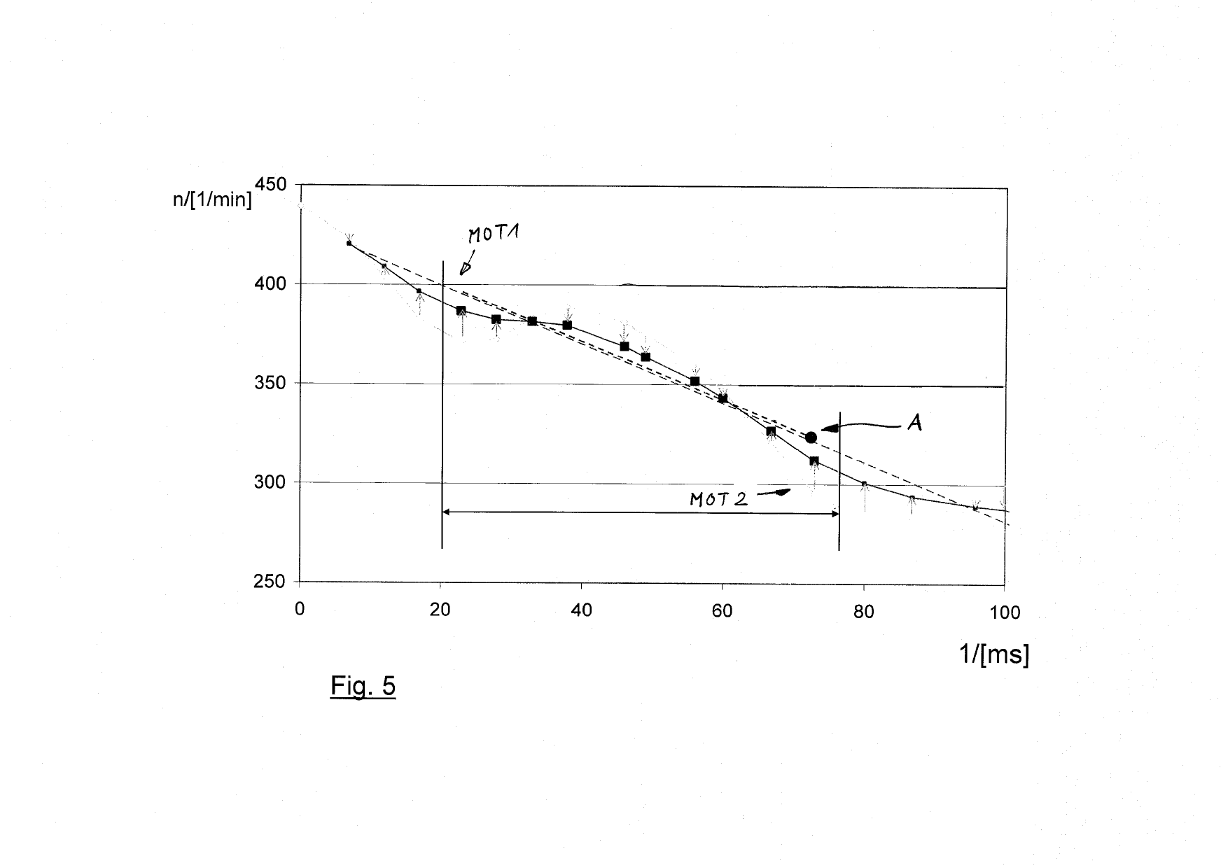

FIG. 5 shows an example of a good periodic determination of a straight trend line. The middle straight trend line shows the correct slope and a fitting end point A. The slope determination of the average straight trend line takes place, in this case, using selected, compensated rotational speeds, in this case, from a minimum MOT1 to another minimum MOT2, i.e., using compensated rotational speeds which occur at top dead center.

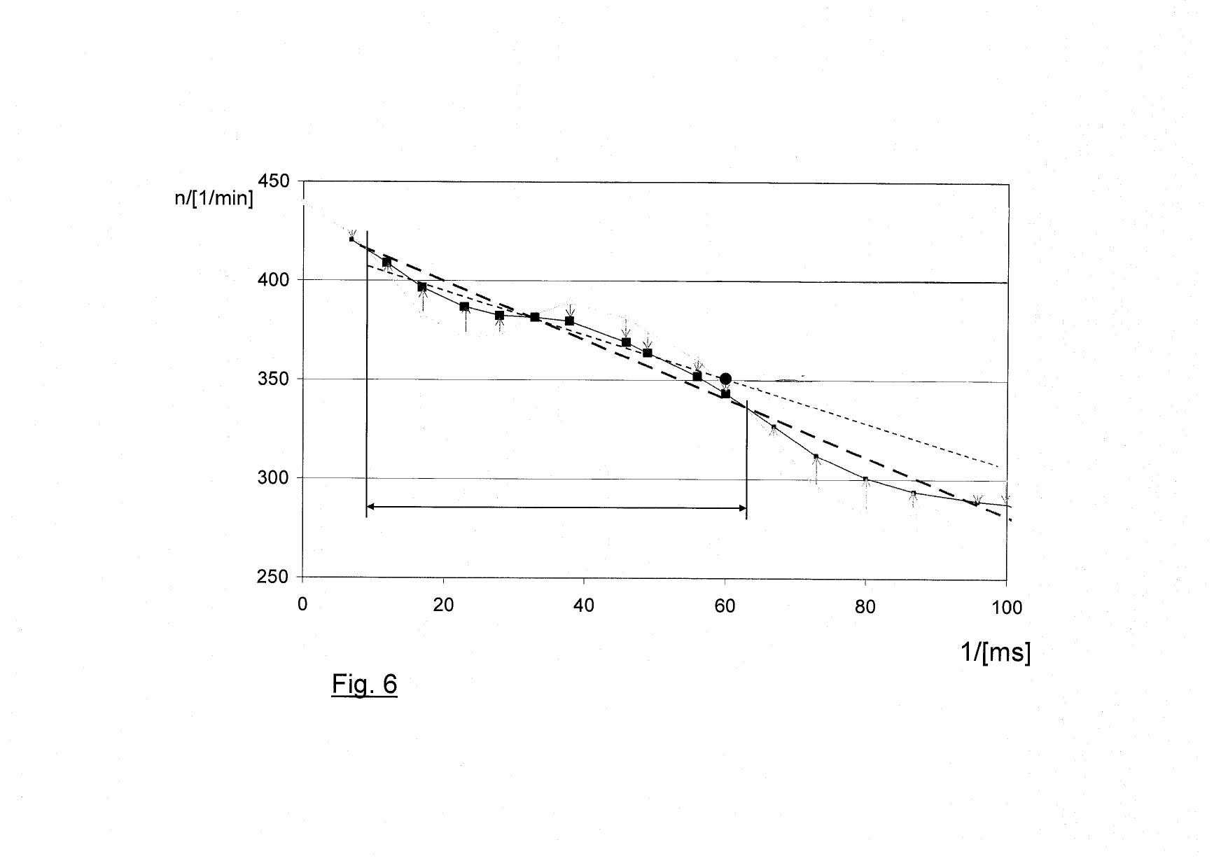

FIG. 6 shows an example of a nonoptimal periodic determination of a straight trend line. In this case, the range has been selected poorly.

In order to keep the deviation of the slope and of the end point of the straight trend line low, additional measures may be taken. For example, the number of points above and below the straight trend lines may be balanced using suitable iterative methods. In this instance, the range is then symmetrically broadened or narrowed about a maximum, as a function of the shape of the ETF characteristics curve. In addition, for the accuracy slope at nonequidistant event points, an additional weighting of the individual points over a suitable density function may be made.

For the ascertainment of the maximum amplitudes and of the amplitude correction factor, the method described in German Application No. DE 10 2010 009 648 A1 is recommended and used.

The interpolation point is the respective end point of the average straight trend line. As the value for the slope, preferably the triple moving average of the last slope values is used.

The slope value is applied at the end point in the direction of earlier times and the maximum amplitude is evaluated at the remarkable crank position values (ETF maxima).

In the case of overcompensation and undercompensation, the determination of the straight trend line is preferably undertaken using the abovementioned optimization approaches (base data from a selected range, balanced number top/bottom weighting depending on the data density).

For the synthesis of the additional rotational speed curve, the method described in Germany Application No. DE 10 2010 009 648 A1 or a similar one is recommended. The interpolation point is the respective end point of the middle straight trend line. As the value for the slope, preferably the triple moving average of the last slope values is used. In the case of overcompensation and undercompensation, the determination of the straight trend line is preferably undertaken using the abovementioned optimization approaches (base data from a selected range, balanced number top/bottom weighting depending on the data density).

After the ascertainment of the first coasting down slope and at each further calculated average coasting down slope, a prediction is calculated. As the rotational speed interpolation point for the prediction calculation, the respective end speed from the calculation of the average straight trend line is used. The forward prediction steps may be based on fixed angle steps, fixed time steps or even other steps and step sizes.

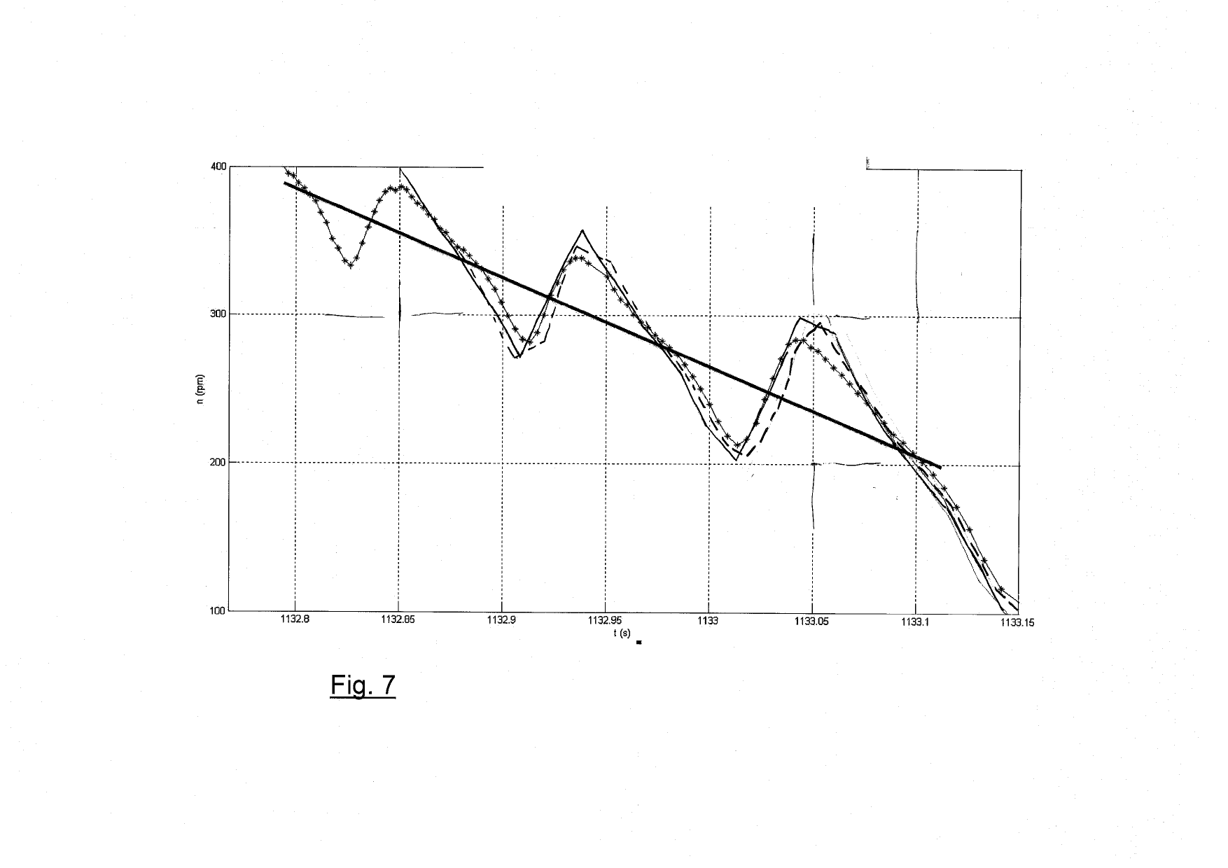

The further procedure for setting up a prediction may be used as described in Germany Application No. DE 10 2010 009 648 A1. The main features are the synthesis of the coasting down on the basis of the average straight trend lines with the addition of the fluctuating speed portion (ETF characteristics curve) multiplied by speed-dependent amplitude (amplitude characteristics curve). FIG. 7 shows a few predictions, for example. The solid straight line corresponds to the average straight trend line, and the dotted curve corresponds to the actual rotational speed curve.

FIG. 8 shows an internal combustion engine 10 having a transmission shaft 13.

The method described for predicting the engine coasting down behavior may be verified on the product itself.

What is claimed is:

1. A method for determining an average rotational speed of a rotating transmission shaft of an internal combustion engine to a rotational position, wherein the rotating transmission shaft takes on various rotational positions and has an actual instantaneous rotational speed at a first time in the rotational position, the method comprising:
determining, at a first approximation in a first step of an iteration, an approximated average rotational speed, as a difference of the actual rotational speed at the first time and in the rotational position, and a product of a weighted amplitude and an angle-dependent amplitude factor.

2. The method according to claim 1, further comprising:
determining, in a further step of the iteration, an additionally approximated average rotational speed, as a difference of the average rotational speed approximately determined in the first step at the first time, and a product of a rotational speed-dependent, weighted amplitude and the angle-dependent amplitude factor.

3. The method according to claim 2, wherein for each point in time, a plurality of iteration steps are carried out in order to ascertain further additionally approximated average rotational speeds.

4. The method according to claim 2, further comprising:
ascertaining a coasting down slope from at least two values for average rotational speeds.

5. The method according to claim 4, wherein the coasting down slope is ascertained using a linear regression method.

6. The method according to claim 4, further comprising:
calculating an average coasting down slope using a plurality of known coasting down slopes for a plurality of points in time.

7. The method according to claim 6, further comprising:
in a case of undercompensated or overcompensated average rotational speed values, selecting certain average rotational speed values in order to, using the selected values, calculate the average coasting down slope.

8. The method according to claim 6, wherein, for the calculation of the average coasting down slope, rotational speed values are used which occur at top dead centers of the internal combustion engine.
